(19) United States
(12) Patent Application Publication
(10) Pub. No.: US 2026/0168731 A1
(43) Pub. Date: Jun. 18, 2026

(54) METHOD FOR GENERATING TRAINED PREDICTION MODEL THAT PREDICTS ENERGY EFFICIENCY OF MELTING FURNACE, METHOD FOR PREDICTING ENERGY EFFICIENCY OF MELTING FURNACE, AND COMPUTER PROGRAM

(71) Applicant: UACJ CORPORATION, Tokyo (JP)

(72) Inventors: Shohei YOMOGIDA, Tokyo (JP); Yuki YAMAMOTO, Tokyo (JP)

(21) Appl. No.: 18/245,716

(22) PCT Filed: Sep. 16, 2021
(86) PCT No.: PCT/JP2021/034191

§ 371 Date: Mar. 16, 2023

(30) Foreign Application Priority Data
Sep. 18, 2020 (JP) 2020-157425

(51) Int. Cl. F27D 21/00; G06N 20/00

(52) U.S. Cl. CPC F27D 21/00; G06N 20/00

(57) ABSTRACT

A method of generating a trained model includes: a step of acquiring a process state parameter for every single charge (S110); a step of performing preprocessing by applying machine learning to a data set of one or more process state parameters acquired through m charges (where m is an integer of 2 or greater) (S130); a step of generating a learning data set (S140); and a step of generating a trained model (S150). The learning data set is generated based on n-dimensional features (where n is an integer of 1 or greater) that have been extracted through the preprocessing, and at least contains one or more process target parameters representing process fundamental information that is set for every single charge.

### TECHNICAL FIELD

The present disclosure relates to a method of generating a trained prediction model to predict the energy efficiency of a melting furnace, a method of predicting the energy efficiency of a melting furnace, and a computer program.

### BACKGROUND ART

Energy saving in melting processes in the steel and nonferrous metal industries is desired. The conditions of melting processes using melting furnaces (blast furnaces) vary depending on various factors, but until now, they have largely depended on the experience and trial-and-error of operators. Therefore, energy and materials were sometimes consumed unnecessarily.

With the recent development of ICT technology, methods for optimizing melting processes by using data have been studied. For example, Patent Document 1 discloses a method which extracts process variables from chronological data measured by various sensors provided in a blast furnace facility, stores them in a search table, searches for process variables with high similarity from the search table, and predicts the future state of a melting process based on past cases of similar melting processes.

### CITATION LIST

### Patent Literature

[Patent Document 1] Japanese Laid-Open Patent Publication No. 2007-4728

### SUMMARY OF INVENTION

### Technical Problem

According to the method described in Patent Document 1, process variables that are extracted from chronological data are used, which makes it possible to determine the process variables required at that point in time with high speed and high accuracy, and to predict the future state of a melting process based on past cases of similar melting processes.

However, the inference algorithm used in the method described in Patent Document 1 is case-study based, which searches for similar melting processes in the past. Therefore, the process variables obtained are only within the range of actual results in the past and in the neighborhood of similar cases thereof. Therefore, it is difficult to obtain a range of solutions that are not in the neighborhood of similar cases.

The present invention has been made in view of the above problems, and an objective thereof is to provide: a method of generating a trained prediction model for predicting the energy efficiency of a melting furnace; a method of predicting an energy efficiency by using the prediction model; and a system which can support the selection of operating conditions for a melting furnace that satisfy a desired energy efficiency by using the prediction model.

### Solution to Problem

In a non-limiting and illustrative embodiment, a method of generating a trained prediction model for predicting an energy efficiency of a melting furnace according to the present disclosure includes: a step of acquiring one or more process state parameters of different attributes for every single charge spanning from a loading of raw materials to a completion of melting, wherein each process state parameter is defined by a continuous aggregate of chronological data that is acquired based on an output from one of a variety of sensors provided in the melting furnace; a step of performing preprocessing by applying machine learning to a data set of the one or more process state parameters acquired through m charges (where m is an integer of 2 or greater), the preprocessing comprising extracting n-dimensional features (where n is an integer of 1 or greater) from each process state parameter containing an aggregate of chronological data acquired for every single charge; a step of generating a learning data set based on the extracted n-dimensional features, the learning data set at least containing one or more process target parameters representing process fundamental information that is set for every single charge; and a step of training a prediction model by using the generated learning data set to generate the trained prediction model.

In a non-limiting and illustrative embodiment, a method of predicting an energy efficiency of a melting furnace according to the present disclosure includes: a step of receiving, as inputs at run time, input data containing control pattern candidates, process pattern candidates, and one or more process target parameters indicating process fundamental information to be set for every single charge spanning from a loading of raw materials to a completion of melting; and a step of inputting the input data to a prediction model and outputting a predicted energy efficiency for every single charge, wherein, the prediction model is a trained model that has been learned by using a learning data set generated by n-dimensional features that are extracted from one or more process state parameters of different attributes; each of the one or more process state parameters is defined by a continuous aggregate of chronological data that is acquired for every single charge based on an output from one of a variety of sensors provided in the melting furnace; and the learning data set contains one or more process target parameters encompassing a data range of the process target parameter or parameters contained in the input data.

In a non-limiting and illustrative embodiment, a computer program according to the present disclosure causes a computer to execute: a step of acquiring a prediction model to predict the energy efficiency of a melting furnace; a step of receiving input data containing control pattern candidates, process pattern candidates, and one or more process target parameters indicating process fundamental information to be set for every single charge spanning from a loading of raw materials to a completion of melting; and a step of inputting the input data to the prediction model and outputting a predicted energy efficiency for every single charge, wherein, the prediction model is a trained model that has been learned by using a learning data set generated by n-dimensional features that are extracted from one or more process state parameters of different attributes; each of the one or more process state parameters is defined by a continuous aggregate of chronological data that is acquired for every single charge based on an output from one of a variety of sensors provided in the melting furnace; and the learning data set contains one or more process target parameters encompassing the process target parameter or parameters contained in the input data.

### Advantageous Effects of Invention

Illustrative embodiments according to the present disclosure provide: a method of generating a trained prediction model for predicting the energy efficiency of a melting furnace; a method of predicting an energy efficiency by using the prediction model; and a system which can support the selection of operating conditions for a melting furnace that satisfy a desired energy efficiency by using the prediction model.

### BRIEF DESCRIPTION OF DRAWINGS

FIG. 1 is a schematic diagram illustrating a configuration for a melting furnace.

FIG. 2 is a block diagram illustrating a schematic configuration of an operation support system for a melting furnace according to an embodiment of the present disclosure.

FIG. 3 is a block diagram showing an example hardware configuration of a data processing device according to an embodiment of the present disclosure.

FIG. 4 is a hardware block diagram showing an example configuration of a cloud server having a database storing huge data.

FIG. 5 is a chart illustrating a processing procedure of generating a trained prediction model for predicting the energy efficiency of a melting furnace according to an embodiment of the present disclosure.

FIG. 6 is a flowchart showing a processing procedure according to a first example implementation.

FIG. 7 is a diagram for describing a process of applying an encoding process to process state parameters to extract an n-dimensional feature vector.

FIG. 8 is a diagram illustrating an example configuration of a neural network.

FIG. 9 illustrates a table containing a predicted energy efficiency for every single charge that is output from the prediction model.

FIG. 10 is a flowchart showing a processing procedure according to a second example implementation.

FIG. 11 is a flowchart showing a processing procedure according to a third example implementation.

FIG. 12 is a diagram for describing a process of applying clustering to an 1×m×n-dimensional feature vector, thereby generating an m-dimensional control pattern vector.

FIG. 13 illustrates a table containing a predicted energy efficiency for every single charge that is output from the prediction model.

FIG. 14 is a flowchart showing a processing procedure according to a fourth example implementation.

FIG. 15 is a diagram for describing a process of applying an encoding process and clustering to an aggregate of chronological process data defining a main process state parameter to generate an m-dimensional process pattern vector.

FIG. 16 illustrates a table containing a predicted energy efficiency for every single charge that is output from the prediction model.

FIG. 17 is a flowchart showing a processing procedure according to a fifth example implementation.

FIG. 18 is a diagram illustrating a process of inputting input data to a trained model and outputting output data containing predicted values of energy efficiency.

FIG. 19A is a graph showing an evaluation result of prediction accuracy in Comparative Example.

FIG. 19B is a graph showing an evaluation result of prediction accuracy in the first example implementation.

FIG. 19C is a graph showing an evaluation result of prediction accuracy in the second example implementation.

FIG. 19D is a graph showing an evaluation result of prediction accuracy in the third example implementation.

FIG. 19E is a graph showing an evaluation result of prediction accuracy in the fourth example implementation.

FIG. 20 is a graph showing an evaluation result of prediction accuracy in the fifth example implementation.

### DESCRIPTION OF EMBODIMENTS

Aluminum alloys and other alloy materials are manufactured through multiple manufacturing processes involving various processes. For example, the manufacturing processes for direct chill (DC) casting of an aluminum alloy may include: a process of melting materials in a melting furnace; a process of holding the melt in a holding furnace to adjust composition and temperature; a process of degassing to remove hydrogen gas by using continuous degassing equipment; a process of removing inclusions by using an RMF (Rigid Media Tube Filter); and a process of casting a slab. The melting process can include, after charging materials into the melting furnace, further processes such as: additional loading of molten metals or raw materials (material recycling); removal of dross; and reheating. This series of processes is in-line processes.

According to a study by the inventor, optimization of the melting process in the in-line processes is complicated because it is affected by subsequent processes. In addition, there are limits to physical-model based simulations, and thus it is difficult to optimize the processes through simulations.

Materials manufacturers can accumulate, in a database, a vast amount of chronological process data acquired during the manufacture phase, for example, over a few, ten, twenty, or even more years. Chronological series process data can be associated with design and development information, climate data during manufacturing, test data, etc., and accumulated in a database. Such an aggregate of data is called big data. However, at present, big data has not been effectively utilized by materials manufacturers.

In view of such problems, the inventor has utilized a data-driven prediction model for energy efficiency that is constructed by using existing big data, and arrived at a novel technique that can optimize melting process conditions.

Hereinafter, with reference to the accompanying drawings, a method of generating a trained prediction model for predicting the energy efficiency of a melting furnace, a method of predicting the energy efficiency of a melting furnace, and an operation support system according to the present disclosure will be described in detail. It should be noted that unnecessarily detailed descriptions may be avoided. For example, to avoid unnecessarily obscuring the present disclosure, well-known features may not be described or substantially the same elements or steps may not be redundantly described, for example. This is also for ease of understanding the present disclosure. In the following description, like elements may be indicated by like reference numerals.

The embodiments described below are for illustrative purposes. Methods of generating a trained prediction model for predicting the energy efficiency of a melting furnace, methods of predicting the energy efficiency of a melting furnace, and operation support systems according to the present disclosure are not limited to the embodiments described below. For example, the numerical values, shapes, materials, steps, and the order of the steps shown in the following embodiments are only examples, and various modifications are possible so long as there is no technical contradiction. One embodiment can be used in combination with another so long as there is no technical contradiction.

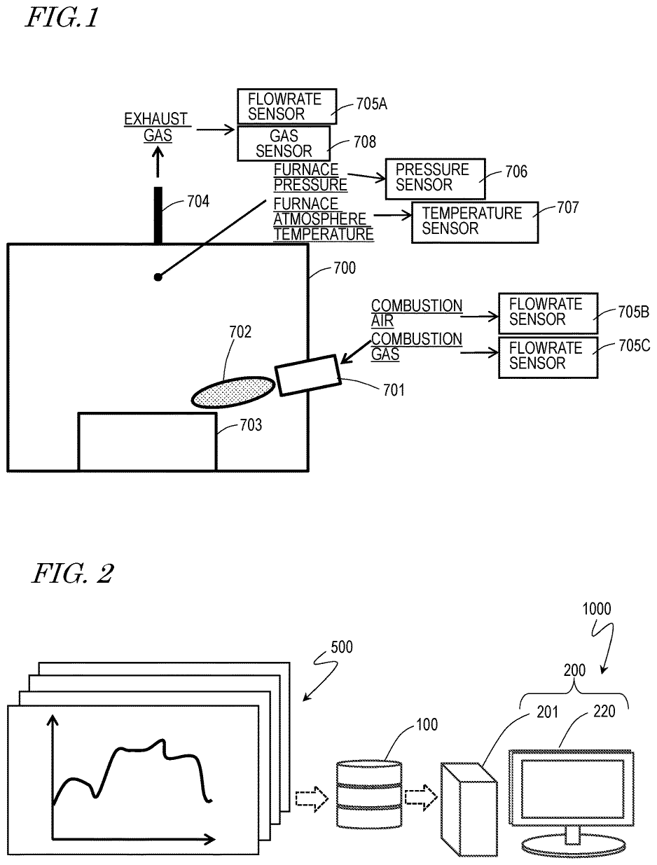

FIG. 1 is a schematic diagram illustrating an exemplary configuration for a melting furnace 700. The melting furnace 700 according to the present embodiment is a top-charge type in which materials 703 are loaded from above. The materials are melted by directly hitting the materials with a flame 702 that is spewed from a high-speed burner 701. One or more sensors can be provided in the melting furnace. In the illustrated example, a flowrate sensor 705A to measure the flowrate of exhaust gas discharged from a flue 704 of the melting furnace 700, a gas sensor 708 to detect specific components in the combustion exhaust gas, a flowrate sensor 705B to measure the flowrate of combustion air in the high-speed burner 701, a flowrate sensor 705C to measure the flowrate of combustion gas in the high-speed burner 701, a pressure sensor 706 to measure the pressure in the melting furnace 700, and a temperature sensor 707 to measure the temperature of the furnace atmosphere in the melting furnace 700 are provided in the melting furnace 700.

The sensors measure data at predetermined sampling intervals. Examples of predetermined sampling intervals are 1 second or 1 minute. The data measured by the sensors is stored in a database 100, for example. Communication between the sensors and the database is realized, for example, by wireless communication compliant with the Wi-Fi (registered trademark) standards.

Now, the terminology used in the present specification will be defined.

In the present embodiment, a predicted value of energy efficiency of a melting furnace means the ratio of a predicted value of fuel usage to an average fuel usage. However, without being limited thereto, a predicted value of energy efficiency of a melting furnace may relate to any predicted value of energy efficiency that may be defined by other calculation formulas. For example, a predicted value of energy efficiency of a melting furnace may be defined by a CO₂ intensity under the international standard ISO 14404.

Chronological data that is acquire based on outputs from the sensors provided in the melting furnace 700 is referred to as “process data”. Examples of process data are an exhaust gas flowrate (mV/h), a combustion air flowrate (m³/h), a combustion gas flowrate (m³/h), a furnace pressure (kPa), a furnace atmosphere temperature (° C.), and an exhaust gas analysis concentration (%).

A continuous aggregate of chronological data that is acquired for every single charge, spanning from the loading of raw materials to the completion of melting, is referred to as a “process state parameter”. In other words, a process state parameter is defined by a continuous chronological aggregate of process data that is acquired for every single charge. Similarly to process data, examples of process state parameters are exhaust gas flowrate, combustion air flowrate, combustion gas flowrate, furnace pressure, and furnace atmosphere temperature.

Data indicating fundamental information of the melting process that is set for every single charge is referred to as a “process target parameter”. Examples of process target parameters are loaded material quantity (ton) and melting time (min). A process target parameter is non-chronological data, and is designated as a specific value.

A parameter that involves an external environmental factor is referred to as a “disturbance parameter”. An example of a disturbance parameter is climate data, such as average temperature (° C.). The climate data is chronological data. Other than climate data, disturbance parameters may include data concerning operators and work groups, work time, and so on, for example.

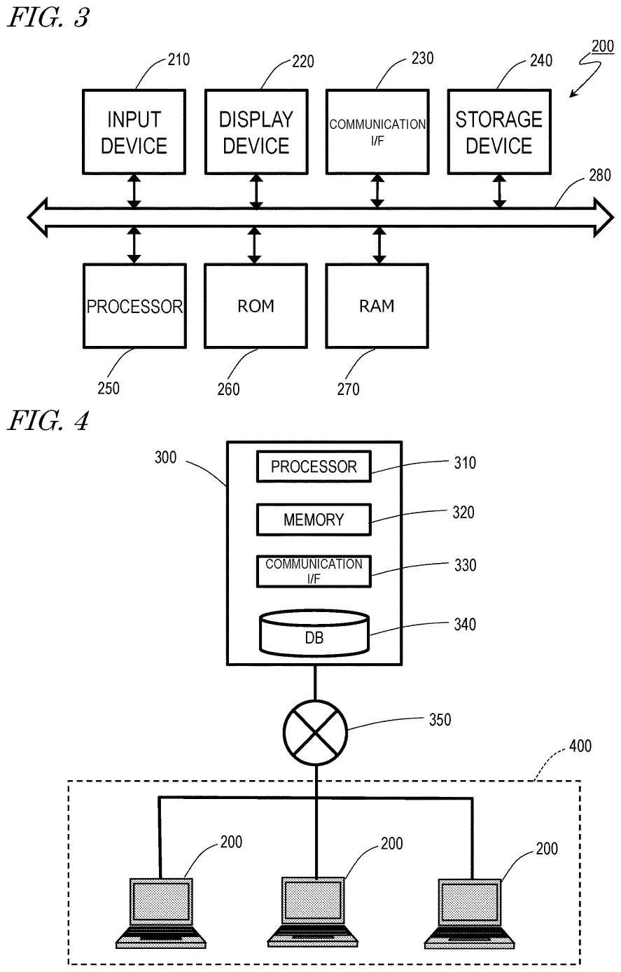

FIG. 2 is a block diagram illustrating a schematic configuration of an operation support system 1000 for a melting furnace according to the present embodiment. The operation support system for a melting furnace (hereinafter simply referred to as a “system”) 1000 includes: a database 100 in which a plurality of chronological process data acquired based on outputs from a plurality of sensors are stored; and a data processing device 200. In the present embodiment, the database 100 stores process state parameters for each of exhaust gas flowrate, combustion air flowrate, combustion gas flowrate, furnace pressure, and furnace atmosphere temperature that have been acquired through a plurality of charges. The database 100 may store process target parameters concerning loaded material quantity and melting time for every single charge. Furthermore, the database 100 may store climate data (such as average temperature) in association with the process target parameters, for example. The data processing device 200 can access huge data that is accumulated in the database 100 to acquire one or more process state parameters of different attributes and one or more process target parameters.

The database 100 is a storage device, such as a semiconductor memory, a magnetic storage device, or an optical storage device.

The data processing device 200 includes a body 201 of the data processing device and a display device 220. For example, software (or firmware) that is used to generate a prediction model for predicting the energy efficiency of a melting furnace using data accumulated in the database 100, and software for predicting energy efficiency by using a trained prediction model at run time, are implemented in the body 201 of the data processing device. Such software may be commercially available as packaged software stored in a computer-readable storage medium, such as an optical disc, or may be provided through the Internet.

The display device 220 is, for example, a liquid crystal display or organic EL display. The display device 220 displays a predicted value of energy efficiency for every charge based on output data that is output from the body 201, for example.

A typical example of the data processing device 200 is a personal computer. Alternatively, the data processing device 200 may be a dedicated device that functions as an operation support system for a melting furnace.

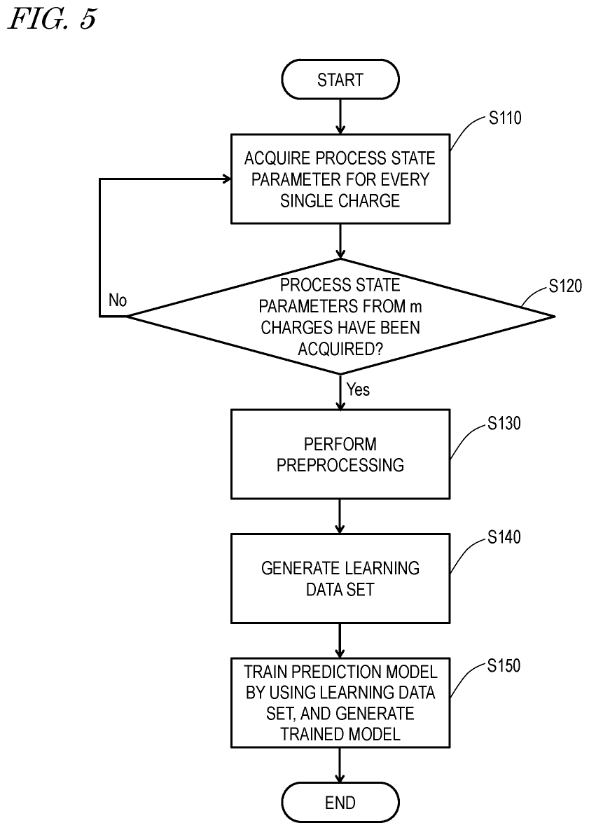

FIG. 3 is a block diagram showing an example hardware configuration of the data processing device 200. The data processing device 200 includes an input device 210, a display device 220, a communication I/F 230, a storage device 240, a processor 250, a ROM (Read Only Memory) 260, and a RAM (Random Access Memory) 270. These constituent elements are connected together through a bus 280 so as to communicate with each other.

The input device 210 converts instructions from the user into data, which is in turn input to the computer. The input device 210 is, for example, a keyboard, mouse, or touch panel.

The communication I/F 230 is an interface for data communication between the data processing device 200 and the database 100. The form and protocol thereof are not limited, as long as data transfer is possible. For example, the communication I/F 230 is capable of wired communication compliant with USB, IEEE1394 (registered trademark), Ethernet (registered trademark), or the like. The communication I/F 230 is capable of wireless communication compliant with the Bluetooth (registered trademark) standard and/or the Wi-Fi standard. These standards include a wireless communication standard that uses the 2.4 GHz or 5.0 GHz frequency band.

The storage device 240 is, for example, a magnetic storage device, an optical storage device, a semiconductor storage device, or a combination thereof. Examples of the optical storage device include optical disk drive s and magneto-optical disk (MD) drives. Examples of the magnetic storage device include hard disk drives (HDDs), floppy disk (FD) drives, and magnetic tape recorders. Examples of the semiconductor storage device include solid-state drives (SSDs).

The processor 250 is a semiconductor integrated circuit, and is also referred to as a central processing unit (CPU) or microprocessor. The processor 250 sequentially executes a computer program that is stored in the ROM 260 and includes instructions to train a prediction model and use the trained model, thereby carrying out a desired process. The processor 250 is to be broadly interpreted as a term encompassing an FPGA (Field Programmable Gate Array), a GPU (Graphics Processing Unit), an ASIC (Application Specific Integrated Circuit) or an ASSP (Application Specific Standard Product) with a CPU mounted thereon.

The ROM 260 is, for example, a writable memory (e.g., a PROM), a rewritable memory (e.g., a flash memory), or a read-only memory. The ROM 260 stores a program that controls operations of the processor. The ROM 260 may not necessarily be a single storage medium, or may be a set of storage media. A portion of the set of storage media may be removable memory.

The RAM 270 provides a work area into which the control program stored in the ROM 260 will be temporarily laid out during boot-up. The RAM 270 may not necessarily be a single storage medium, and may be a set of storage media.

Some representative example configurations of the system 1000 according to the present disclosure will be described below.

In an example configuration, the system 1000 includes the database 100 and the data processing device 200 shown in FIG. 1. The database 100 is a piece of hardware distinct from the data processing device 200. Alternatively, a storage medium such as an optical disc that stores huge data may be read into the body 201 of the data processing device, and therefore, instead of the database 100, the storage medium may be accessed so that huge data can be read.

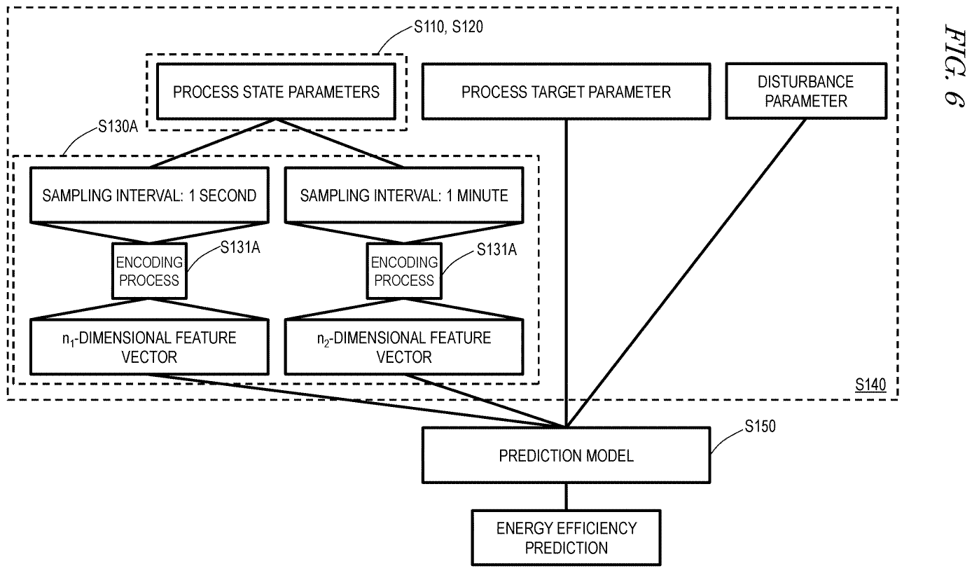

FIG. 4 is a hardware block diagram showing an example configuration of a cloud server 300 having a database 340 storing huge data.

In another example configuration, as shown in FIG. 4, the system 1000 includes one or more data processing devices 200 and the database 340 of the cloud server 300. The cloud server 300 includes a processor 310, a memory 320, a communication I/F 330, and the database 340. The huge data may be stored in the database 340 of the cloud server 300. For example, the plurality of data processing devices 200 may be connected together through a local area network (LAN) 400 constructed within the company. The local area network 400 is connected to the Internet 350 through an Internet provider service (IPS). Each data processing device 200 can access the database 340 of the cloud server 300 through the Internet 350.

The system 1000 may include one or more data processing devices 200 and the cloud server 300. In that case, in the place of the processor 250 included in the data processing device 200 or in cooperation with the processor 250, the processor 310 included in the cloud server 300 can sequentially execute a computer program including instructions to train a prediction model and use the trained model. Alternatively, for example, a plurality of data processing devices 200 connected to the same LAN 400 may execute the computer program including such instructions in cooperation with one another. Such a distributed process performed by the plurality of processors can reduce calculation load on each processor.

### <1. Generation of Trained Prediction Model>

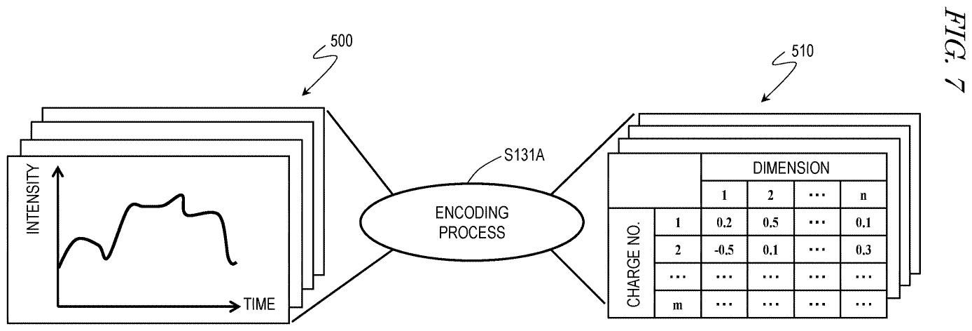

FIG. 5 is a chart illustrating a processing procedure of generating a trained prediction model for predicting the energy efficiency of a melting furnace according to the present embodiment. Hereinafter, a trained prediction model will be referred to as a “trained model”.

A trained model according to the present embodiment predicts the energy efficiency of a melting furnace that is used in the manufacture of an aluminum alloy. However, the trained model may also be used to predict the energy efficiency of a melting furnace that is used for the manufacture of any alloy material other than aluminum alloys.

A method of generating a trained model according to the present embodiment includes: step S110 of acquiring a process state parameter for every single charge; step S120 of determining whether process state parameters from m charges (where m is an integer of 2 or greater) have been acquired or not; step S130 of performing preprocessing; step S140 of generating a learning data set; and step S150 of generating a trained model.

It is one or more processors that performs each process (or task). One processor may perform one or more processes, or a plurality of processors may work in cooperation to perform one or more processes. The processes are to be described in a computer program as software modules. However, in the case where an FPGA or the like is used, all or some of these processes may be implemented as a hardware accelerator. In the following description, it is the data processing device 200 including the processor 250 that performs each step.

At step 110, the data processing device 200 accesses the database 100 to acquire or obtain one or more process state parameters of different attributes for every single charge spanning from the loading of raw materials to the completion of melting. In the present embodiment, the data processing device 200 accesses respective aggregates of process data of exhaust gas flowrate, combustion air flowrate, combustion gas flowrate, furnace pressure, and furnace atmosphere temperature that are stored in the database 100, and obtain process state parameters for every single charge. In other words, as process state parameters, the five of exhaust gas flowrate, combustion air flowrate, combustion gas flowrate, furnace pressure, and furnace atmosphere temperature are acquired for every single charge.

The data processing device 200 may access the database 100 after aggregates of chronological process data from a plurality of charges have been stored to the database 100, and acquire the process state parameters from the plurality of charges all in once (off-line processing). Alternatively, the data processing device 200 may access the database 100 every time an aggregate of chronological process data from one charge is stored to the database 100, and acquire a process state parameter from one charge (on-line processing).

At step S120, the data processing device 200 repeatedly performs step S110 until process state parameters from m charges have been acquired. The number m of charges in the present embodiment may be about 1000, for example. Once acquiring a data set containing process state parameters from m charges, the data processing device 200 proceeds to the next step S130. The data set contains process state parameters for the five of exhaust gas flowrate, combustion air flowrate, combustion gas flowrate, furnace pressure, and furnace atmosphere temperature that have been acquired through m charges.

At step 130, the data processing device 200 applies machine learning to the data set acquired at step S120, thereby performing preprocessing. With respect to each process state parameter of a different attribute, the preprocessing extracts n-dimensional features (where n is an integer of 1 or greater) from the process state parameter containing an aggregate of chronological data acquired for every single charge. In the present specification, n-dimensional features may be expressed as an n-dimensional feature vector.

Examples of machine learning to be applied in the preprocessing according to the present embodiment include autoencoders such as convolutional autoencoders (CAE), variational autoencoders (VAE), and clustering such as k-means technique, c-means technique, mixed Gaussian distribution (GMM), dendrogram methods, spectral clustering or probabilistic latent semantic analysis methods (PLSA or PLSI). The preprocessing will be described in detail later.

At step S140, the data processing device 200 generates a learning data set based on the n-dimensional features extracted from each process state parameter for every single charge. The learning data set at least contains one or more process target parameters representing process fundamental information that is set for every single charge. The learning data set may further contain one or more disturbance parameters, among which external environmental factors, e.g., climate data, may be included. In the present embodiment, the learning data set includes two process target parameters of loaded material quantity and melting time, as well as a disturbance parameter of average temperature. However, the learning data set may contain other process target parameters and disturbance parameters. Although disturbance parameters are not essential parameters, they may be included in the learning data set to improve the prediction accuracy for energy efficiency.

At step S150, the data processing device 200 trains a prediction model by using the generated learning data set, thereby generating a trained model. In the present embodiment, the prediction model, which is a supervised prediction model, is constructed by a neural network. An example of the neural network is a multilayer perceptron (MLP). The MLP is also called a feedforward neural network. The supervised prediction model is not limited to neural networks, and may, for example, be a support-vector machine, random forest, or the like.

The trained model that predicts the energy efficiency of a melting furnace according to the present embodiment can be generated in accordance with various processing procedures (i.e., algorithms). Hereinafter, first to fourth example implementations of the algorithm will be described. In each of the first to fourth example implementations, a distinct preprocessing is performed. A computer program containing instructions that describe any such algorithm may be supplied through the Internet, for example. Hereinafter, the distinct preprocessing in each example implementation will mainly be described.

### First Example Implementation

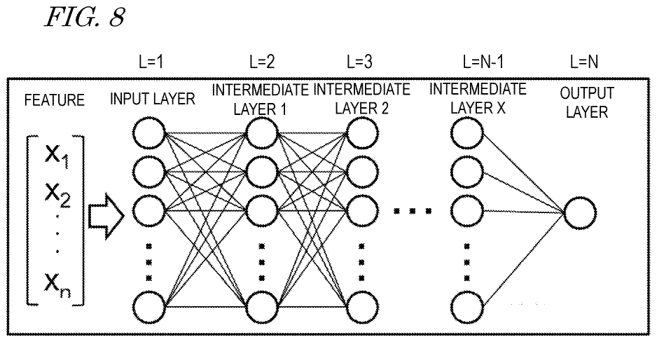

FIG. 6 is a flowchart showing a processing procedure according to the first example implementation.

A process flow according to the first example implementation includes a step (S110, S120) of acquiring process state parameters, step S130A of performing preprocessing, step S140 of generating a learning data set, and step S150 of generating a previously trained model.

The data processing device 200 acquires a data set containing process state parameters from m charges. In this example implementation, the data set contains process state parameters for the five of exhaust gas flowrate, combustion air flowrate, combustion gas flowrate, furnace pressure, and furnace atmosphere temperature that have been acquired through m charges.

The sampling intervals of the respective sensors vary depending on the attribute of the data to be measured. For example, the process data of exhaust gas flowrate, combustion air flowrate, combustion gas flowrate, and furnace pressure are measured by the flowrate sensor 705 and the pressure sensor 706 with a sampling interval of 1 second, whereas the furnace atmosphere temperature is measured by the temperature sensor 707 with a sampling interval of 1 minute.

At step 130, with respect to each process state parameter, the data processing device 200 applies an encoding process S131A to the respective process state parameter containing an aggregate of chronological data acquired for every single charge to extract n-dimensional features (or an n-dimensional feature vector). In the present embodiment, the dimensional number of the features to be extracted differs depending on the sampling interval of the sensor. For any process parameter defined by an aggregate of chronological process data that is measured with a sampling interval of 1 second, the data processing device 200 extracts an n₁-dimensional feature vector. For any process parameter defined by chronological process data that is sampled with a sampling interval of 1 minute, the data processing device 200 extracts an n:-dimensional feature vector. In this example implementation, the data processing device 200 extracts a 20-dimensional feature vector from the respective process state parameters of exhaust gas flowrate, combustion air flowrate, combustion gas flowrate, and furnace pressure, and extracts a 5-dimensional feature vector from the process state parameter of furnace atmosphere temperature.

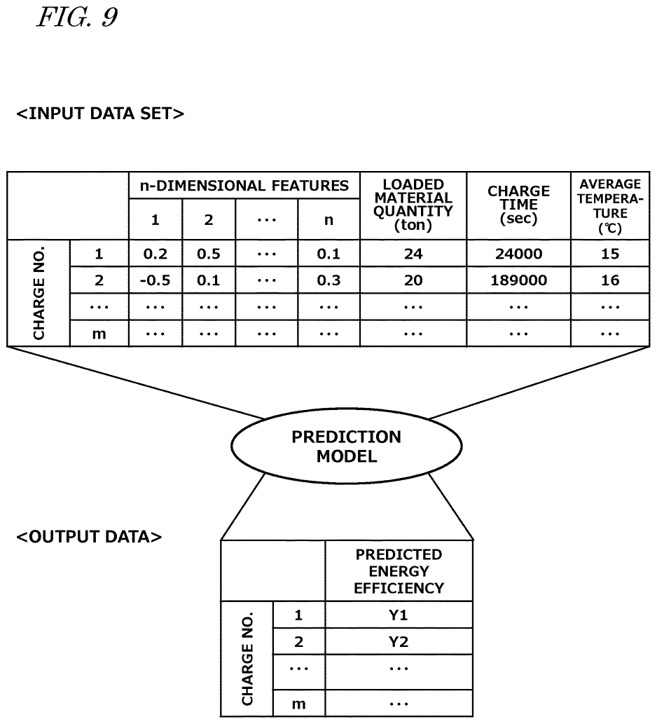

FIG. 7 is a diagram for describing a process of applying the encoding process S131A to the process state parameters 500 to extract an n-dimensional feature vector. In the encoding process S131A, a vector conversion model of CAE or VAE, which are kinds of autoencoders, is applied. Now, CAE and VAE will be briefly described.

An autoencoder is a machine learning model that iteratively learns parameters so that the input and the output match through dimensional compression (encoding) on the input side and dimensional expansion (decoding) on the output side. The learning by an autoencoder can be unsupervised or supervised learning. A CAE has a network structure that utilizes convolutional layers, instead of fully-connected layers, for the encoding and decoding portions. A VAE, on the other hand, has intermediate layers each represented as a random variable (latent variable) that follows an N-dimensional normal distribution. The latent variable, which is a dimensional compression of the input data, can be used as a feature.

In this example implementation, the encoding process 8131A is a CAE. As is illustrated in FIG. 7, by applying a CAE to the process state parameters 500, the data processing device 200 is able to extract an n-dimensional feature vector for every single charge from an aggregate of chronological process data defining a process state parameter. The aggregate of chronological process data defining each process state parameter is expressed as 30000-dimensional features, for example. Herein, 30000 dimensions correspond to the number of samplings made during one charge (30000 times).

By applying a CAE to the process state parameters 500, the data processing device 200 generates an m×n-dimensional feature vector for every process state parameter. Given that there are 1 process state parameters, an 1×m×n-dimensional feature vector 510 is generated as a whole. In FIG. 7, a table of m×n-dimensional feature vectors, in which n-dimensional feature vectors are arrayed in a charge-by-charge manner, is depicted for each process state parameter.

Using representative values, such as mean values, integral values, and slopes, which can be subjected to scrutiny by operators and skilled workers, may result in oversights, because they can only be calculated to the extent that they allow scrutiny by them. On the other hand, applying an encoding process to the process state parameters 500 makes it possible to extract features with a high accuracy, and may even allow unexpected features to be extracted.

FIG. 6 is referred to again.

At step 140, the data processing device 200 generates a learning data set that contains the 1×m×n-dimensional feature vector 510 generated at step S130, a process target parameter(s), and a disturbance parameter(s). In this example implementation, the learning data set contains an [m×20]-dimensional feature vector concerning the respective process state parameters of exhaust gas flowrate, combustion air flowrate, combustion gas flowrate, and furnace pressure; an [m×5]-dimensional feature vector concerning the process state parameter of furnace atmosphere temperature; loaded material quantity (process target parameter); melting time (process target parameter); and average temperature (disturbance parameter).

At step S150, the data processing device 200 uses the learning data set generated at step S140 to train a prediction model, thereby generating a trained model. In this example implementation, the prediction model is an MLP.

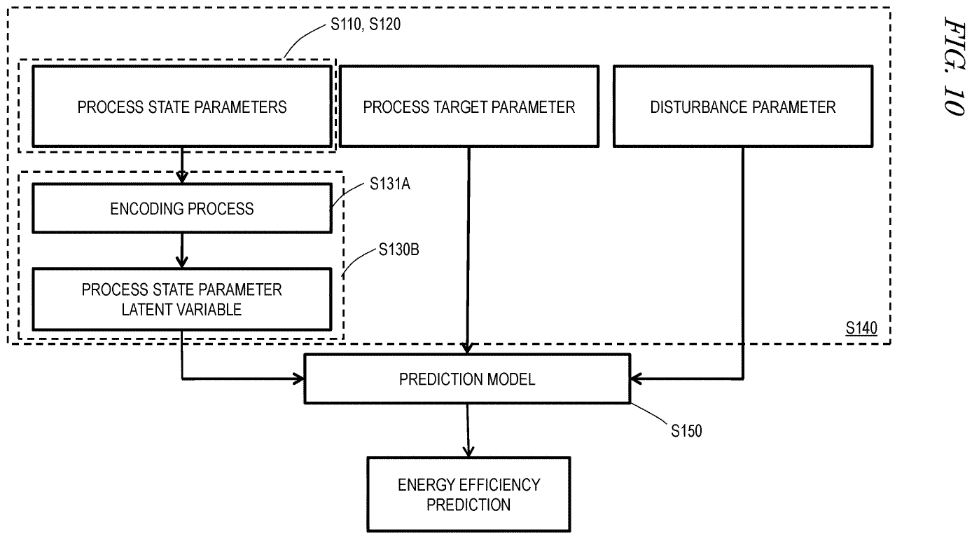

FIG. 8 is a diagram illustrating an example configuration of a neural network. The illustrated neural network is an MLP that includes N layers, from an input layer as the first layer to an output layer as the N^{th} layer (last layer). Among the N layers, the second to (N−1)^{th} layers are called intermediate layers (or “hidden layers”). The number of units (also referred to as “nodes”) included in the input layer is n, which is the same as the dimensional number of the features that are input data. In other words, the input layer consists of n units. The output layer consists of one unit. In this example implementation, the number of intermediate layers is 10, and the total number of units is 500.

In MLPs, information propagates from the input side to the output side in one direction. Each unit receives a plurality of inputs, and calculates a single output. Assuming that the plurality of inputs are [x₁, x₂, x₃, . . . , xᵢ (i is an integer of two or greater)], the overall input to the unit is obtained by multiplying the respective inputs x by different weights w, adding them up, and adding a bias b to this, which is represented by equation 1. Herein, [w₁, w₂, w₃, . . . , wᵢ] are weights for the respective inputs. The output z of the unit is given as the output of a function f called an activation function for all inputs u, which is represented by equation 2. The activation function is typically a monotonically increasing nonlinear function. An example of the activation function is a logistic sigmoid function, which is represented by equation 3. In equation 3, e represents Napier's constant.

$$u = {x}_{1} {w}_{1} + {x}_{2} {w}_{2} + {x}_{3} {w}_{3} + … + {w}_{i} {w}_{i} + b \qquad [ equation 1 ]$$

$$z = f ( u ) \qquad [ equation 2 ]$$

$$f ( u ) = 1 / ( 1 + {e}^{- u} ) \qquad [ equation 3 ]$$

Between layers, each unit in one layer is connected to every unit in the other. As a result, an output of a unit in a left layer is an input of a unit in a right layer, which connection allows a signal to propagate from the left layer to the right layer in one direction. By determining the outputs of the layers sequentially while optimizing the parameters, i.e., the weights w and the bias b, the final output of the output layer is obtained.

As training data, actual values of energy efficiency are used. The parameters (the weights w and the bias b) are optimized based on a loss function (squared error) such that the output of the output layer of the neural network approaches the actual value. In this example implementation, learning is performed 10000 times, for example.

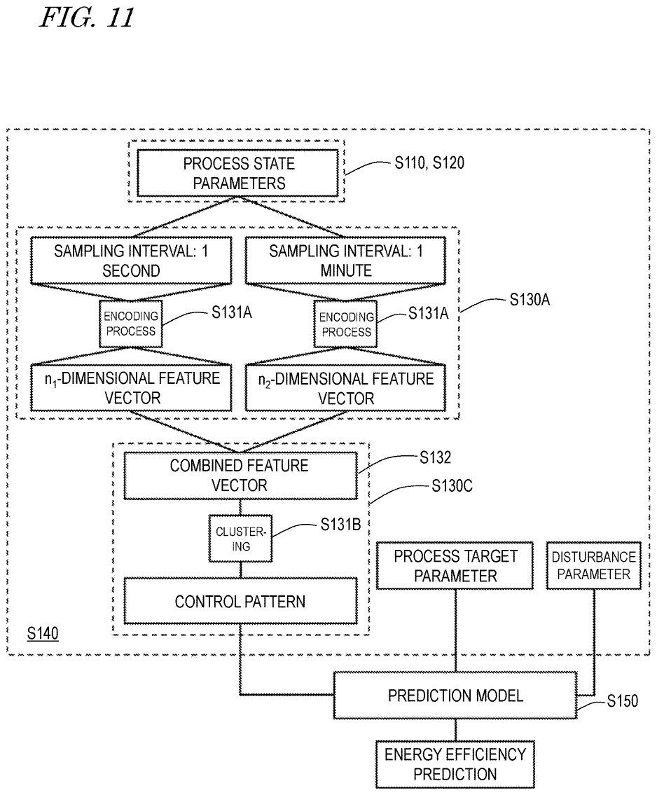

FIG. 9 illustrates a table containing a predicted energy efficiency for every single charge that is output from the prediction model. As a result of training the prediction model, as is illustrated in FIG. 9, a predicted value of energy efficiency for every single charge is obtained as output data. This predicted value of energy efficiency can be displayed on the display device 220, for example. The operator can check the list of predicted values of energy efficiency displayed on the display device 220, and on the basis of these predicted values of energy efficiency, select desired operating conditions for the melting furnace.

### Second Example Implementation

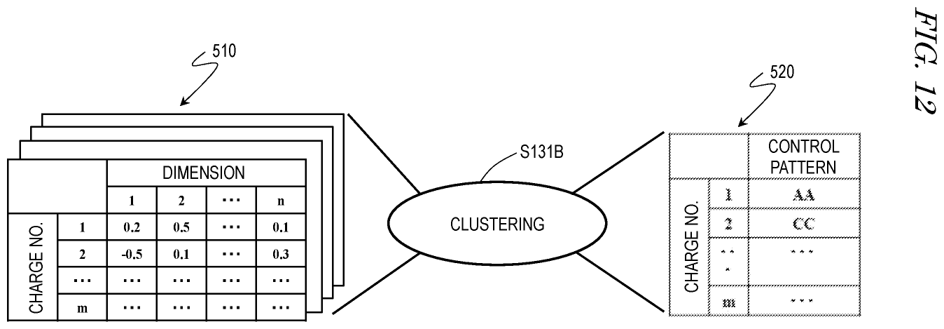

FIG. 10 is a flowchart showing a processing procedure according to the second example implementation.

The preprocessing according to the second example implementation differs from that of the first example implementation in that a VAE is applied as the encoding process S131A. Hereinafter, differences from the first example implementation will mainly be described.

At step 130B, with respect to each process state parameter, the data processing device 200 applies a VAE as the encoding process S131A to an aggregate of chronological process data acquired for every single charge to extract n-dimensional features.

In this example implementation, by applying a VAE to the process state parameter, the data processing device 200 is able to subject the input aggregate of chronological process data to dimensional compression, thus converting it into a latent variable of a lower dimension. For example, an aggregate of chronological process data that is expressed as a 30000-dimensional feature can be converted into a latent variable of 10 dimensions.

According to this example implementation, by applying a VAE to the aggregate of chronological process data, it is possible to extract a 10-dimensional feature vector for each process state parameter. Using a prediction model that is generated by integrating a VAE and a neural network makes it possible to predict energy efficiency with a high accuracy. Furthermore, data generation based on a VAE, i.e., using a latent variable that has been compressed to a lower dimension, is useful in terms of allowing a chronological process assessment. For example, it become possible to tune the operating conditions of the melting furnace for each process step.

### Third Example Implementation

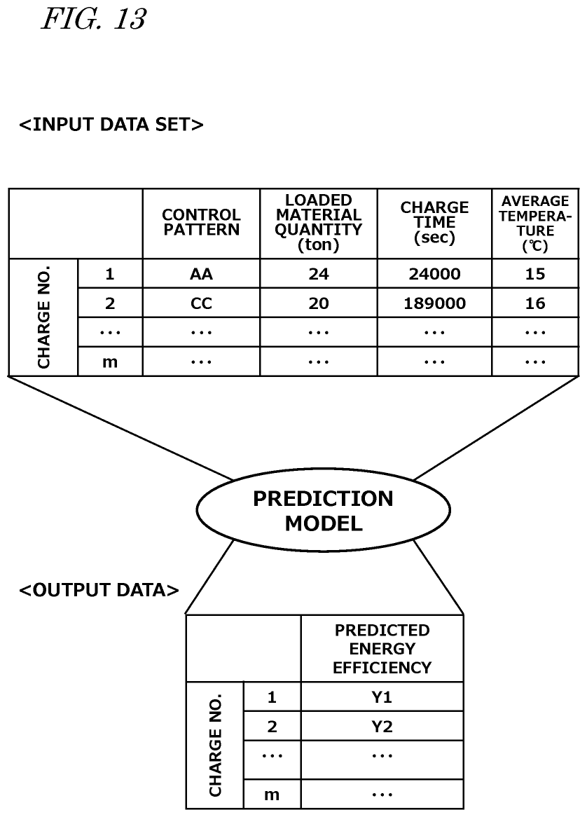

FIG. 11 is a flowchart showing a processing procedure according to the third example implementation.

The third example implementation differs from the first or second example implementation in that a control pattern is generated based on n-dimensional features. Hereinafter, differences will mainly be described.

The data processing device 200 finds a pattern in an aggregate of chronological process data defining each process state parameter on the basis of the extracted n-dimensional features, thereby determining a control pattern.

The preprocessing according to this example implementation includes: step S130A of applying an encoding process S131A to the aggregate of chronological process data defining a process state parameter to extract n-dimensional features; and step 130C of applying a clustering S131B to combined features (or a combined feature vector) to generate a control pattern. The process of step S130A is as has been described with respect to the first example implementation. Examples of clustering are GMM and K-means. In this example implementation, the clustering is GMM. Hereinafter, representative algorithms of GMM and k-means technique will be briefly described. These algorithms can be relatively easily implemented in the data processing device 200.

### (Mixed Gaussian Distribution)

Mixed Gaussian distribution (GMM) is a method of analysis based on probability distributions, and is a model that is expressed as a linear combination of multiple Gaussian distributions. The model is fitted by the maximum likelihood method, for example. In particular, when there are multiple clusters in the data aggregate, the mixed Gaussian distribution can be used for clustering. From given data points, GMM calculates the mean and variance of each of the multiple Gaussian distributions.
(i) Mean value and variance of each Gaussian distribution are initialized.
(ii) Weights to be given to the data points are calculated for each cluster.
(iii) Based on the weights calculated in (ii), the mean value and variance of each Gaussian distribution are updated.
(iv) Until change in the mean value of each Gaussian distribution as updated in (iii) becomes sufficiently small,
(ii) and (iii) are repeated.
   (k-Means Technique)

Because k-means technique is relatively simple, and is applicable to relatively large data, k-means technique is broadly used in data analysis.
(i) From among multiple data points, as many arbitrary points are selected as there are clusters, and these are designated as the centroids (or representative points) of the clusters. The data are also referred to as “records”.
(ii) The distance between each data point and the centroid of each cluster is calculated, and from among the as many centroids as there are clusters, the cluster whose centroid is at the closest distance is defined as the cluster to which that data point belongs.
(iii) For each cluster, a mean value of the multiple data points belonging to that cluster is calculated, and the data point that exhibits the mean value is defined as a new centroid of that cluster.
(iv) Until movements of all data points between clusters subside or the upper limit number of computation steps is reached, (ii) and (iii) are repeated.

At step S130C, the data processing device 200 performs clustering for the n-dimensional features extracted at step S130A as input data, thereby determining a control pattern containing a label indicating a group that each process of the m charges belongs to. For example, the clustering can classify the input n-dimensional feature vector into 10 groups.

At step S132, the data processing device 200 combines all of the n-dimensional feature vector acquired from each process state parameter for every single charge to generate a combined feature vector for every single charge. For example, the data processing device 200 combines a 20-dimensional feature vector that has been extracted from each of exhaust gas flowrate, combustion air flowrate, combustion gas flowrate, and furnace pressure and a 5-dimensional feature vector extracted from furnace atmosphere temperature, thereby generating a 85-dimensional combined feature vector for every single charge. In the end, the data processing device 200 will have generated an 85-dimensional combined feature vector for the m charges.

The data processing device 200 applies clustering to the combined feature vector, thereby determining a control pattern containing a label indicating a group that each process of the m charges belongs to. By performing clustering, the data processing device 200 classifies the combined feature vector for every single charge into 10 groups, for example. The data processing device 200 generates an m-dimensional control pattern vector 520 that is defined by m control patterns for the m charges.

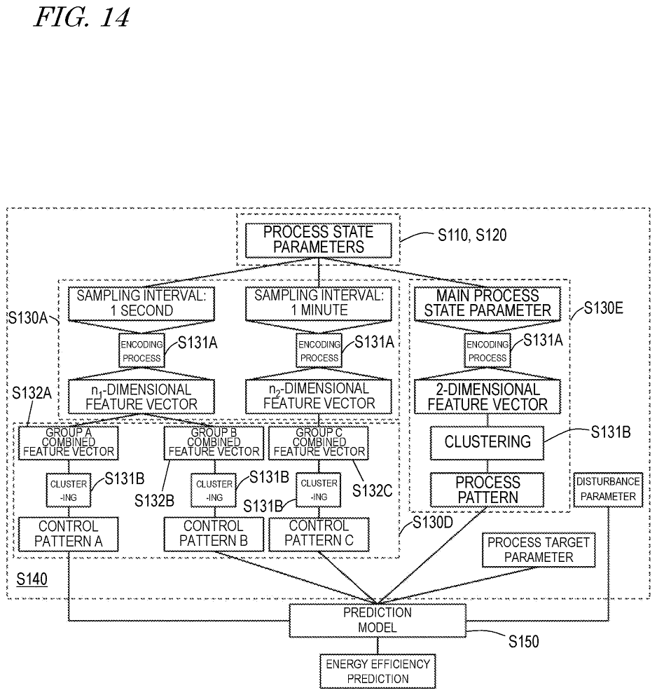

FIG. 12 is a diagram for describing a process of applying clustering S131B to the 1×m×n-dimensional feature vector 510 generated at step S130, thereby generating the m-dimensional control pattern vector 520. The control pattern may include 10 patterns from labels AA to JJ, for example. The control pattern is a control state of the melting furnace being extracted as a pattern. More specifically, it is a pattern expression of the control state of the melting furnace mainly focusing on temporal changes, slight fluctuations, and minute differences of the chronological process data. The control state of the melting furnace may mean a state associated with a high combustion gas flowrate in an early stage of melting, a state associated with a low furnace pressure in a later stage of melting, and so on, for example. However, as will be described later, the control pattern may also include information concerning the operations of the melting furnace.

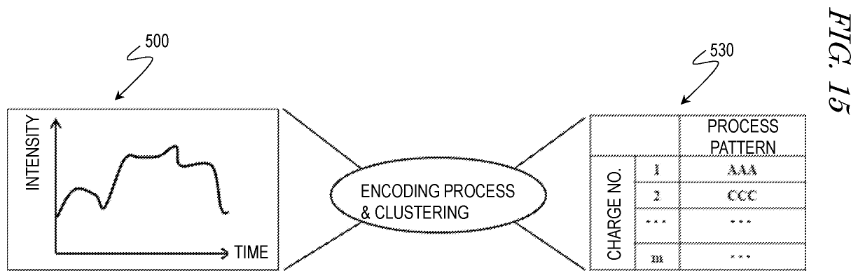

FIG. 13 illustrates a table containing a predicted energy efficiency for every single charge that is output from the prediction model. In this example implementation, in addition to a process target parameter(s) and a disturbance parameter(s), the learning data set contains an m-dimensional control pattern vector. Inclusion of the m-dimensional control pattern vector in the learning data set allows the prediction accuracy for energy efficiency to be improved. For example, effects of the minute fluctuations in the chronological process data can be suppressed, whereby an improved robustness is provided. By linking them to actual operations, it may become easier to control the melting furnace under desired operating conditions for the melting furnace.

Similarly to the first or second example implementation, as a result of training the prediction model, as is illustrated in FIG. 13, a predicted value of energy efficiency for every single charge is obtained as output data.

### Fourth Example Implementation

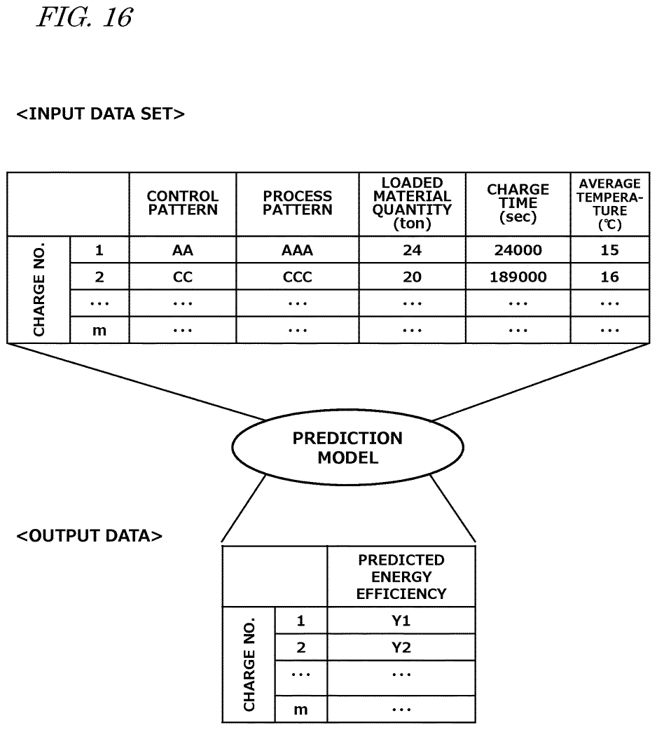

FIG. 14 is a flowchart showing a processing procedure according to the fourth example implementation.

The fourth example implementation differs from the first, second, or third example implementation in that a process pattern is generated based on a main process state parameter. Hereinafter, differences will mainly be described.

In this example implementation, the preprocessing includes: step S130D of generating a control pattern based on n-dimensional features that have been extracted at step S130A; and step S130E of generating a process pattern based on a main process state parameter.

The process of step S130A is as has been described in the third Example. In other words, for example, the data processing device 200 extracts a 20-dimensional feature vector from an aggregate of chronological process data defining each of exhaust gas flowrate, combustion air flowrate, combustion gas flowrate, and furnace pressure, and extracts a 5-dimensional feature vector from an aggregate of chronological process data defining furnace atmosphere temperature.

The process of step S130D differs from the process of step S130C of the third example implementation. The difference is that a process state parameter(s) associated with the same sampling interval are classified into two or more groups. At step S130D, the data processing device 200 combines all of the n-dimensional features that are acquired from each of at least one process state parameter belonging to the same group for every single charge, to generate combined features for each group. In the fourth example implementation, among multiple process state parameters that have been acquired with a sampling interval of 1 second, the three of exhaust gas flowrate, combustion air flowrate, and combustion gas flowrate are assigned to group A, while furnace pressure is assigned to group B. Furnace atmosphere temperature is assigned to group C because there is one process state parameter that has been acquired with a sampling interval of 1 minute.

The data processing device 200 combines all of the 20-dimensional feature that have been extracted from each of the process state parameters of exhaust gas flowrate, combustion air flowrate, and combustion gas flowrate belonging to group A, to generate combined features for the respective group. The combined features in group A have 60 dimensions. The data processing device 200 combines all of the 20-dimensional feature that have been extracted from the process state parameter of furnace pressure belonging to group B, to generate combined features for the respective group. In this case, because there is only one kind that needs feature combination, the combined features in group B have 20 dimensions, which is the same dimensions as those of the furnace pressure features. The data processing device 200 combines all of the 5-dimensional feature that have been extracted from the process state parameter of furnace atmosphere temperature belonging to group C, to generate combined features for the respective group. Because there is only one kind that needs feature combination, the combined features in group C have 5 dimensions, which is the same dimensions as those of the furnace atmosphere temperature.

By applying the clustering S131B to the combined features for each group, the data processing device 200 determines for each group a control pattern containing a label indicating a group that each process of the m charges belongs to. In this example implementation, the clustering is GMM. For example, by GMM, the input n-dimensional features may be classified into 10 groups.

By applying GMM to the 60-dimensional combined features in group A, the data processing device 200 generates an m-dimensional control pattern vector containing a control pattern A for every single charge. By applying GMM to the 20-dimensional combined features in group B, the data processing device 200 generates an m-dimensional control pattern vector containing a control pattern B for every single charge. By applying clustering to the 5-dimensional combined features in group C, the data processing device 200 generates an m-dimensional control pattern vector containing a control pattern C for every single charge. Each of the control patterns A, B and C may include 10 patterns from labels AA to JJ, for example. Control patterns A are control patterns concerning burner control; control patterns B are control patterns concerning the furnace pressure pattern; and patterns C are control patterns concerning temperature.

At step S130E, the data processing device 200 applies machine learning to an aggregate of chronological process data defining at least one of the one or more process state parameters to find a pattern in each process of the m charges, thereby determining a process pattern. To explain in more detail, the data processing device 200 applies an encoding process and clustering to an aggregate of chronological process data defining one of the main process state parameters, thereby determining a process pattern containing a label indicating a group that each process of the m charges belongs to.

Main process state parameters refer to those parameters among the one or more process state parameters which directly govern the melting process. For example, the energy efficiency of the melting furnace is largely governed by the opening and closing of the furnace lid, the turning ON/OFF of the burner, and so on. Therefore, in the present embodiment, the parameters which reflect these are regarded as the main process state parameters. An example of a main process state parameter is the combustion gas flowrate.

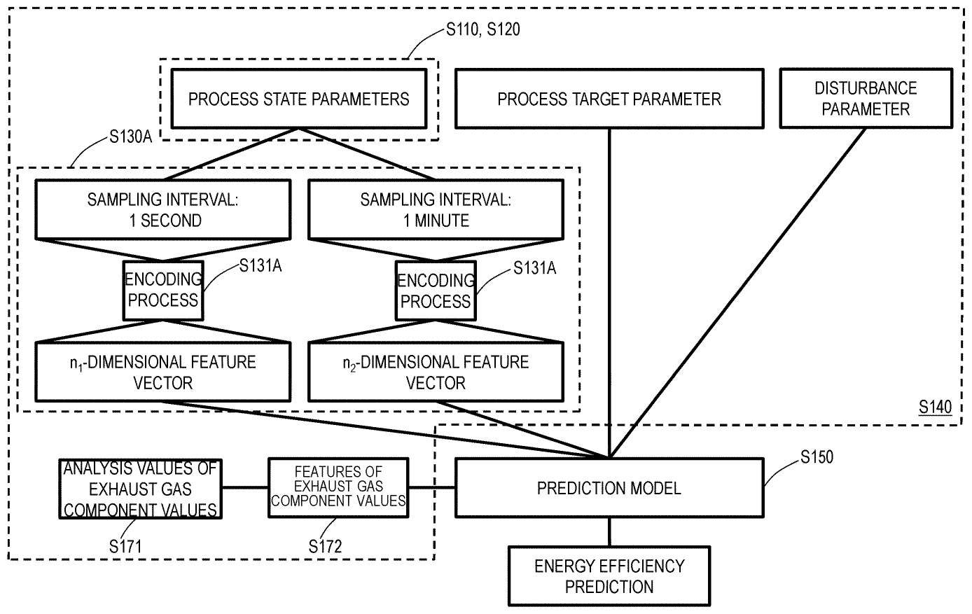

FIG. 15 is a diagram for describing a process of applying an encoding process and clustering to an aggregate of chronological process data defining the main process state parameter to generate an m-dimensional process pattern vector 530.

At step S130E, the data processing device 200 applies an encoding process and clustering to an aggregate of chronological process data defining one of the main process state parameters among the one or more process state parameters, thereby determining a process pattern containing a label indicating a group that each process of the m charges belongs to. In this example implementation, the encoding process is VAE, and the clustering is k-means technique.

The process pattern may include 4 patterns from labels AAA to DDD, for example. The process pattern relates to the work required in the melting process. The process pattern is a pattern expression of an aggregate of chronological process data defining the main process state parameter, focusing on the combination of the presence/absence of work, work sequence, and work timing, where characteristic features are extracted. Similarly to the process pattern, the aforementioned control pattern may contain information concerning work, but is different from the process pattern in that it contains information other than work, e.g., information such as the control state of the melting furnace, for example.

The data processing device 200 applies a VAE to an aggregate of chronological process data defining combustion gas flowrate, and extracts e.g., a 2-dimensional feature from the process state parameter of combustion gas flowrate for every single charge. By applying k-means technique to the extracted 2-dimensional feature, the data processing device 200 determines a process pattern containing a label indicating a group that each process of the m charges belongs to. The data processing device 200 generates an m-dimensional process pattern vector 530 containing a process pattern for every single charge.

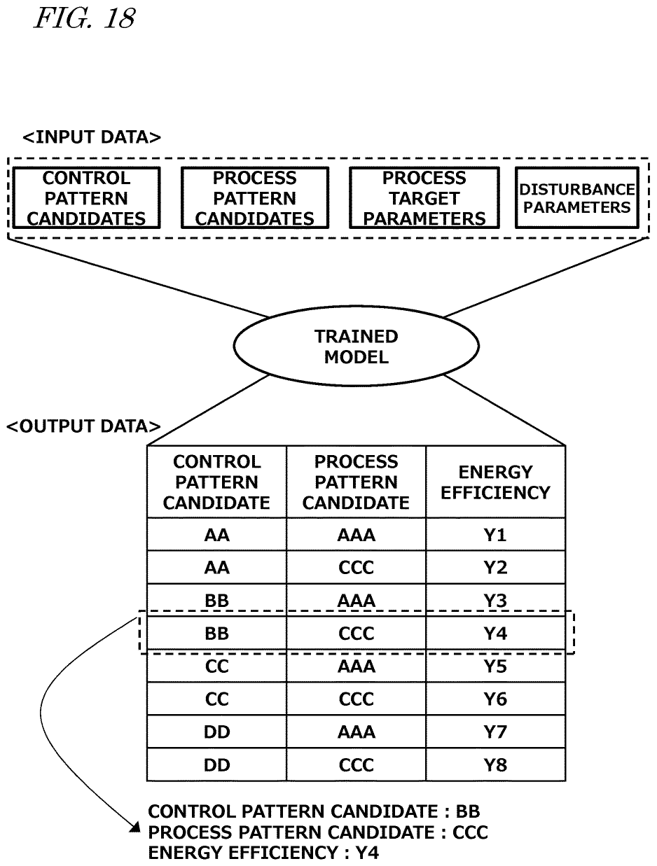

FIG. 16 illustrates a table containing a predicted energy efficiency for every single charge that is output from the prediction model. In this example implementation, in addition to a process target parameter(s), a disturbance parameter, and an m-dimensional control pattern vector, the learning data set contains an m-dimensional process pattern vector. Applying clustering in the process of generating a process pattern may produce a result which is different from that obtained by an operator performing the classification, for example, thus enabling an objective extraction of a process pattern. This can improve the prediction accuracy for energy efficiency.

Preferably, hyperparameters are adjusted for the trained model, thereby optimizing the accuracy of the prediction model. This adjustment can be performed by using a grid search, for example.

A method of generating a trained prediction model according to an embodiment of the present disclosure may further include a step of acquiring one or more other process state parameters that are distinct from the one or more process state parameters, and extracting features from the acquired one or more other process state parameters by a classical method. The other process state parameter(s) is distinct from the aforementioned process state parameters such as exhaust gas flowrate, combustion air flowrate, and combustion gas flowrate. The other process state parameter (s) is a component value of a combustion exhaust gas of the melting furnace, or the combustion exhaust gas temperature, for example. The learning data set may be generated based on the extracted n-dimensional features and the feature(s) extracted by the classical method.

### Fifth Example Implementation

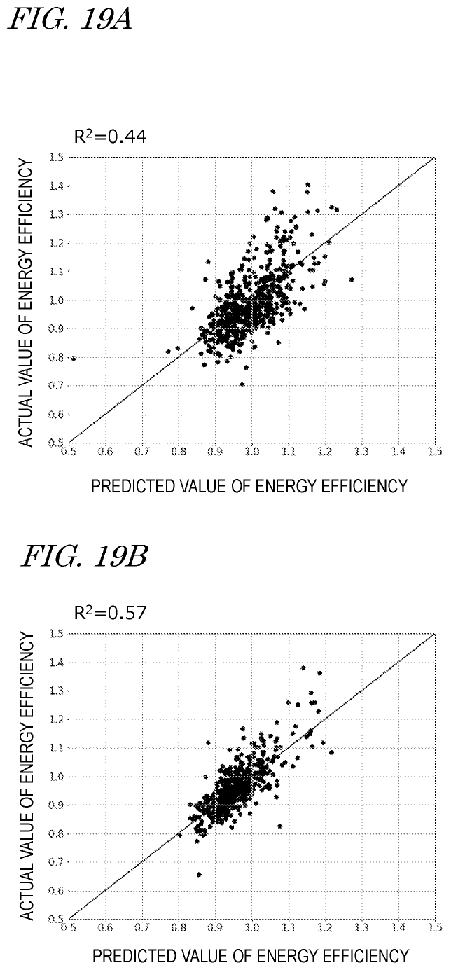

FIG. 17 is a flowchart showing a processing procedure according to the fifth example implementation.

The fifth example implementation differs from the first example implementation in that a learning data set is generated based on n-dimensional features extracted by applying machine learning and a feature(s) extracted by a classical method. Hereinafter, differences will mainly be described.

The other process state parameter in the fifth example implementation is a component value of a combustion exhaust gas of the melting furnace. The process flow according to the fifth example implementation further includes: step (S171) of continuously analyzing a component value of the combustion exhaust gas of the melting furnace to acquire analysis data of the exhaust gas component value; and a step (S172) of extracting, from the acquired analysis data, the feature(s) of the exhaust gas component value during burner combustion by a classical method. Examples of classical methods may be theoretically- or empirically-based.

At step S171, the data processing device 200 acquires continuous aggregates of data of component values of various combustion exhaust gases, e.g., O₂, CO, CO₂, NO, and NO₂, based on an output value output from a combustion exhaust gas analysis device that includes the gas sensor 708, for example. For example, continuous aggregates of data may be acquired for every single charge. The data processing device 200 analyzes the continuous aggregates of data to acquire analysis data of each exhaust gas component value. An example of a gas component value is the concentration of a gas component.

At step S172, from analysis data acquired for each exhaust gas component, the data processing device 200 extracts the feature(s) of an exhaust gas component value during burner combustion for each exhaust gas component. The feature(s) of an exhaust gas component value may be expressed as a 1-dimensional feature vector, for example. As the feature of an exhaust gas component value, a median of an analysis value that is acquired by analyzing data which is obtained during burner combustion may be used, for example.

At step S140, the data processing device 200 generates a learning data set based on n-dimensional features extracted by applying machine learning and a feature(s) of exhaust gas component values extracted by a classical method. In this example implementation, the data processing device 200 generates a learning data set containing an 1×m×n-dimensional feature vector 510 generated at step S130, a process target parameter(s), a disturbance parameter(s), and the feature of the exhaust gas component value extracted at step S172.

Because an exhaust gas component value is special process data, it is preferable to extract its features by a classical method rather than by machine learning. Therefore, this example implementation treats component values of combustion exhaust gases distinctly from the aforementioned process state parameters. However, exhaust gas component values may be treated as a kind of process state parameter, and their features may be extracted by applying machine learning to the component values of combustion exhaust gases as has been described in the first example implementation.

At step S150, the data processing device 200 uses the learning data set generated at step S140 to train a prediction model, thereby generating a trained model.

### <2. Run Time>

By using inputting input data containing control pattern candidates, process pattern candidates, and the like as the aforementioned trained model, it becomes possible to predict the energy efficiency of a melting furnace, or output a control pattern and a process pattern conducive to an energy efficiency that satisfies a predetermined reference value. The predetermined reference value may be set as a target value of energy efficiency.

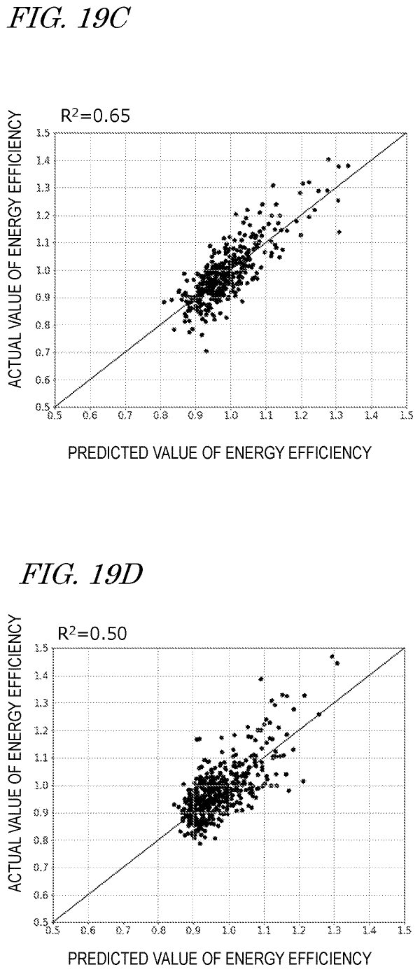

FIG. 18 is a diagram illustrating a process of inputting input data to a trained model and outputting output data containing predicted values of energy efficiency.

A method of predicting the energy efficiency of a melting furnace according to the present embodiment includes: a step of receiving, as inputs at run time, input data containing control pattern candidates, process pattern candidates, one or more process target parameters indicating process fundamental information to be set for every single charge spanning from the loading of raw materials to the completion of melting, and one or more disturbance parameters; and a step of inputting the input data to a trained model and outputting a predicted energy efficiency for every single charge. However, if the learning data set used when causing the prediction model to learn does not contain any disturbance parameters, the input data at run time does not contain any disturbance parameters. In the present embodiment, it is assumed that the input data contains disturbance parameters.

The trained model can be generated according to the aforementioned first to fourth example implementations, for example. The learning data set to be used in training the prediction model contains one or more process target parameters encompassing the data range of the process target parameter(s) contained in the input data, and one or more disturbance parameters encompassing the data range of the disturbance parameter(s) contained in the input data. Stated otherwise, the one or more process target parameters in the input data are selected from within the data range of one or more process target parameters contained in the learning data set. Similarly, the one or more disturbance parameters in the input data are selected from within the data range of one or more disturbance parameters contained in the learning data set.

Now, the control pattern candidates and the process pattern candidates will be described.

The control pattern candidates include all control patterns that were generated through the preprocessing when generating the prediction model. When four kinds (patterns AA, BB, CC and DD) of control patterns are generated through the preprocessing, all of the four patterns qualify as control pattern candidates. The control pattern that is conducive to the highest energy efficiency may vary depending on the process target parameters, process patterns, and disturbance parameters contained in the input data. Therefore, the present embodiment adopts a method where, a desirable control pattern is selected from among control pattern candidates, in order to optimize the control pattern in accordance with changes in the process target parameters, process patterns, and disturbance parameters. The desirable control pattern means a control pattern which is conducive to an energy efficiency that satisfies a predetermined reference value, i.e., a target value.

Process pattern candidates are process patterns which have been selected by an operator as selectable candidate patterns in the melting process, from among process patterns which were generated through the preprocessing when generating the prediction model. Process pattern candidates are used in the sense of constraints in selecting a desirable control pattern. The operator is able to select one or more process pattern candidates in accordance with the work schedule, for example. For instance, given that the process patterns which were generated through the preprocessing include the four pattern of pattern AAA (number of times material is loaded: once, cleaning of furnace interior: NO), pattern BBB (number of times material is loaded: once, cleaning of furnace interior: YES), pattern CCC (number of times material is loaded: twice, cleaning of furnace interior: NO), and pattern DDD (number of times material is loaded: twice, cleaning of furnace interior: YES), consider a case where the number of times material is loaded in the melting process may be arbitrary, and no cleaning of furnace bed is required. In that case, the operator may select the two of pattern AAA and pattern CCC as the selectable candidate patterns via the input device 210 of the data processing device 200, for example.

FIG. 18 illustrates a table of output data which is output from the trained model in the case where control pattern candidates including four patterns AA to DD and process pattern candidates including two patterns AAA and CCC that have been selected by the operator are input as the input data.

The output data associates all combinations of control pattern candidates and process pattern candidates with predicted values of energy efficiency. These predicted values of energy efficiency are charge-by-charge predicted values. In the illustrated example, correspondence between eight combinations and predicted values of energy is shown. From among the eight combinations, the data processing device 200 selects a combination of a control pattern candidate and a process pattern candidate conducive to an energy efficiency that satisfies the target value as the desirable control pattern and process pattern. The data processing device 200 may output the selected control pattern and process pattern to the display device 220 for displaying, or output to a log file, for example. In the illustrated example, a result is shown where control pattern candidate BB and process pattern candidate CCC are selected as the desirable control pattern and process pattern satisfying the target value.

### EXAMPLES

Through comparison with Comparative Example, the inventor has examined the prediction accuracies for energy efficiency in the first to fourth example implementations. In Comparative Example, mean values were calculated from chronological process data defining process state parameters, and these were used for the input data as representative values. In Comparative Example, energy efficiency was predicted through multiple regression, and the prediction accuracy was calculated.

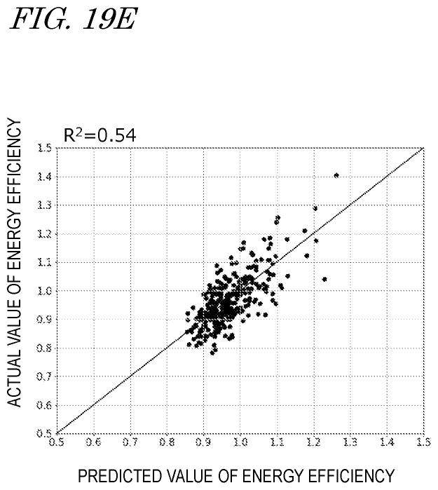

FIG. 19A to FIG. 19E are graphs showing evaluation results of prediction accuracy for Comparative Example and the first to fourth example implementations, respectively. In the graph, the horizontal axis represents predicted values of energy efficiency (a.u.), and the vertical axis represents actual values of energy efficiency (a.u.). In each graph, a straight line indicating predicted value=actual value is shown. The predicted value of energy efficiency indicates a ratio (Q1/P) of the predicted value of fuel usage Q1 to the average fuel usage P, whereas the actual value of energy efficiency indicates a ratio (Q2/P) of the actual value of fuel usage Q2 to the average fuel usage P.

In Comparative Example, the coefficient of determination R² is 0.44. In the first to fourth example implementations, the coefficients of determination R² are, respectively, 0.57, 0.65, 0.50 and 0.54. The coefficients of determination R² in the first to fourth example implementations were all greater than the coefficient of determination R² in Comparative Example. Among the first to fourth example implementations, the second example implementation is considered as one of the optimum models for accurately predicting the energy efficiency.

The prediction accuracy for energy efficiency in the fifth example implementation was also examined. In this examination of prediction accuracy, the feature of exhaust gas component values was also added in the calculation. Comparative Example was as described above.

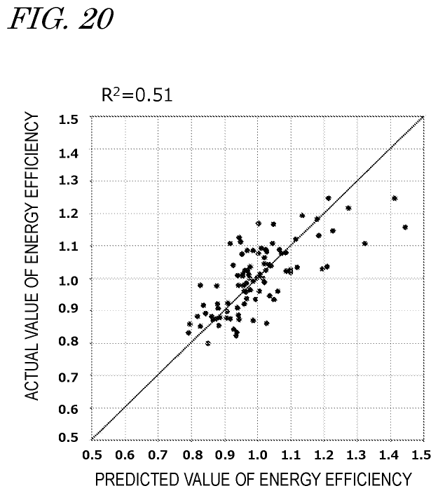

FIG. 20 is a graph showing an evaluation result of prediction accuracy in the fifth example implementation. In the graph, the horizontal axis represents predicted values of energy efficiency (a.u.), and the vertical axis represents actual values of energy efficiency (a.u.). In the graph, a straight line indicating predicted value=actual value is shown. The graph showing an evaluation result of prediction accuracy in Comparative Example is as indicated in FIG. 19A.

The coefficient of determination R² in Comparative Example is 0.44, whereas the coefficient of determination R % in the fifth example implementation is 0.51. The coefficient of determination R² in the fifth example implementation was also greater than the coefficient of determination R² in Comparative Example. Adding the feature of exhaust gas component values allows for an analysis based on component values of exhaust gas.

According to the present embodiment, a prediction model that is generated by integrating an encoding process such as CAE or VAE, clustering such as GMM or k-means, and a supervised prediction model such as a neural network is used to enable prediction of energy efficiency with a high accuracy. Moreover, there is provided an operation support system for a melting furnace which, under a desired furnace operating schedule and amounts of material inputs, allows for recommending a control pattern and a process pattern that maximizes energy efficiency by using a trained model.

### INDUSTRIAL APPLICABILITY

The technique according to the present disclosure may be widely used in support systems which, in addition to generating a prediction model to predict the energy efficiency of a melting furnace used for the manufacture of an alloy material, selects operating conditions for the melting furnace by using a trained model.

### REFERENCE SIGNS LIST

100, 340: storage device (database)
200: data processing device
201: body of data processing device
210: input device
220: display device
230, 330: communication I/F
240: storage device
250, 310: processor
260: ROM
270: RAM
280: bus
300: cloud server
320: memory
350: Internet
400: local area network
700: melting furnace
701: high-speed burner
702: flame
703: material
704: flue
705A, 705B, 705C: flowrate sensor
706: pressure sensor
707: temperature sensor
708: gas sensor
1000: operation support system

1. A method of generating a trained prediction model for predicting an energy efficiency of a melting furnace, comprising:
a step of acquiring one or more process state parameters of different attributes for every single charge spanning from a loading of raw materials to a completion of melting, wherein each process state parameter is defined by a continuous aggregate of chronological data that is acquired based on an output from one of a variety of sensors provided in the melting furnace;
a step of performing preprocessing by applying machine learning to a data set of the one or more process state parameters acquired through m charges (where m is an integer of 2 or greater), the preprocessing comprising extracting n-dimensional features (where n is an integer of 1 or greater) from each process state parameter containing an aggregate of chronological data acquired for every single charge;
a step of generating a learning data set based on the extracted n-dimensional features, the learning data set at least containing one or more process target parameters representing process fundamental information that is set for every single charge; and
a step of training a prediction model by using the generated learning data set to generate the trained prediction model.

2. The method of claim 1, wherein the learning data set contains one or more disturbance parameters.

3. The method of claim 2, wherein the one or more disturbance parameters include an external environmental factor.

4. The method of claim 1, wherein,
the preprocessing further comprises finding a pattern in an aggregate of chronological data defining each process state parameter on the basis of the extracted n-dimensional features to determine a control pattern; and
the learning data set further contains the control pattern.

5. The method of claim 4, wherein the preprocessing performs clustering for the extracted n-dimensional features as input data to determine the control pattern, the control pattern containing a label indicating a group that each process of the m charges belongs to.

6. The method of claim 4, wherein,
the preprocessing further comprises applying machine learning to an aggregate of chronological data defining at least one of the one or more process state parameters to find a pattern in each process of the m charges and determine a process pattern; and
the learning data set further contains the process pattern.

7. The method of claim 6, wherein the preprocessing applies an encoding process and clustering to an aggregate of chronological data defining one of main process state parameters among the one or more process state parameters that directly governs a melting process to determine the process pattern, the process pattern containing a label indicating a group that each process of the m charges belongs to.

8. The method of claim 7, wherein the one of main process state parameters is a combustion gas flowrate.

9. The method of claim 1, wherein,
the preprocessing further comprises
combining all of the n-dimensional features acquired from each process state parameter for every single charge to generate combined features for every single charge, and
applying clustering to the combined features to determine a control pattern containing a label indicating a group that each process of the m charges belongs to; and
the learning data set further contains the control pattern.

10. The method of claim 1, wherein,
the one or more process state parameters are classified into two or more groups;
the preprocessing further comprises
combining all of the n-dimensional features that are acquired from each of at least one process state parameter belonging to the same group for every single charge to generate combined features for each group, and
applying clustering to the combined features for every group to determine for each group a control pattern containing a label indicating a group that each process of the m charges belongs to; and
the learning data set further contains the control pattern for each group.

11. The method of claim 10, wherein,
the preprocessing further comprises applying an encoding process and clustering to an aggregate of chronological data defining one of main process state parameters among the one or more process state parameters that directly governs a melting process to determine a process pattern containing a label indicating a group that each process of the m charges belongs to; and
the learning data set further contains the process pattern.

12. The method of claim 1, further comprising a step of acquiring one or more other process state parameters that are distinct from the one or more process state parameters, and extracting features from the acquired one or more other process state parameters by a classical method, wherein
the step of generating the learning data set comprises generating the learning data set based on the extracted n-dimensional features and the features extracted by the classical method.

13. The method of claim 12, wherein the one or more other process state parameters comprise a component value of a combustion exhaust gas of the melting furnace.

14. The method of claim 1, wherein the trained prediction model predicts an energy efficiency of a melting furnace used for manufacturing an aluminum alloy.

15. A method of predicting an energy efficiency of a melting furnace, comprising:
a step of receiving, as inputs at run time, input data containing control pattern candidates, process pattern candidates, and one or more process target parameters indicating process fundamental information to be set for every single charge spanning from a loading of raw materials to a completion of melting; and
a step of inputting the input data to a prediction model and outputting a predicted energy efficiency for every single charge, wherein,
the prediction model is a trained model that has been learned by using a learning data set generated by n-dimensional features that are extracted from one or more process state parameters of different attributes;
each of the one or more process state parameters is defined by a continuous aggregate of chronological data that is acquired for every single charge based on an output from one of a variety of sensors provided in the melting furnace; and
the learning data set contains one or more process target parameters encompassing a data range of the process target parameter or parameters contained in the input data.

16. The method of claim 15, wherein,
the input data further contains one or more disturbance parameters; and
the learning data set further contains one or more disturbance parameters encompassing a data range of the disturbance parameter contained in the input data.

17. The method of claim 15, further comprising a step of displaying a predicted energy efficiency for every single charge on a display device.

18. The method of claim 15, further comprising a step of inputting the input data to the prediction model and outputting a control pattern and a process pattern conducive to an energy efficiency that satisfies a predetermined reference value.

19. A computer program, stored on a non-transitory computer readable storage medium, for causing a computer to execute:
a step of acquiring a prediction model to predict the energy efficiency of a melting furnace;
a step of receiving input data containing control pattern candidates, process pattern candidates, and one or more process target parameters indicating process fundamental information to be set for every single charge spanning from a loading of raw materials to a completion of melting; and
a step of inputting the input data to the prediction model and outputting a predicted energy efficiency for every single charge, wherein,
the prediction model is a trained model that has been learned by using a learning data set generated by n-dimensional features that are extracted from one or more process state parameters of different attributes;
each of the one or more process state parameters is defined by a continuous aggregate of chronological data that is acquired for every single charge based on an output from one of a variety of sensors provided in the melting furnace; and
the learning data set contains one or more process target parameters encompassing a data range of the process target parameter or parameters contained in the input data.

20. The computer program of claim 19, wherein,
the input data further contains one or more disturbance parameters; and
the learning data set further contains one or more disturbance parameters encompassing a data range of the disturbance parameter contained in the input data.
